(19) United States
(12) Patent Application Publication
(10) Pub. No.: US 2007/0214677 A1
(43) Pub. Date: Sep. 20, 2007

(54) SYSTEM FOR HEATING BULK MATERIALS

(76) Inventors: James C. Kennedy, St. Louis, MO (US); Nassib Aouad, St. Louis, MO (US)

Correspondence Address: GLENN L. WEBB, P.O BOX 951, CONIFER, CO, 80433, US

(21) Appl. No.: 11/277,030

(22) Filed: Mar. 20, 2006

(51) Int. Cl. F26B 25/06

(52) U.S. Cl. 34/201

(57) ABSTRACT

A system for heating bulk material to remove moisture. The system includes a heat exchanger system in the floor of a bin for receiving moist bulk material. The heat exchanger system is capable of withstanding the weight of the bulk material as well as being stable for the dynamic process of loading and discharging the bulk material. The heat exchanger includes a plurality of spaced beams mounted between a top plate and bottom plate. The spaced beams form conduits for receiving water or other fluids that have been heated by a stove capable of burning wood, coal, biomass material or other energy sources. The stove is capable of providing one million BTUs, or any type of heat exchanger, including existing commercially available units for heat exchange or heat transfer.

### FIELD OF THE INVENTION

This invention relates to the field of removing moisture from bulk materials by heat.

### BACKGROUND OF THE INVENTION

Raw bulk materials, such as ores, commercial minerals, soda ash, phosphate, bauxite, oil shale, oil sands, coke, coal, molybdenum, alumina, carbon black, sodium and other bulk materials initially are mined, processed or otherwise collected containing a significant amount of moisture. These materials may be mined in remote locations, processed in chemical processing plants, in industrial plants and in any number of site locations. It is beneficial to reduce the moisture content of the bulk material before transporting or otherwise processing the bulk material. For example, iron ore contains between fifteen and twenty-five percent moisture after it is mined. The reduction in the moisture not only reduces the weight of the ore but also is necessary before the ore can be further processed. Many other bulk materials contain moisture as well that must be reduced before the material can be further processed.

Presently, there are a number of systems for reducing the moisture content in bulk materials. These systems range from rotating dryers, indirect thermal processors, airflow heating systems and other complex mechanical dryers to heat the bulk material to reduce the moisture content. These dryers attempt to provide heat to the bulk material either by airflow through the material or by an indirect heat exchanger that rotates material by an indirect heat exchanger. These systems require movement and contamination of the material which increases the complexity and the cost of the system. These systems also have expensive fuel and operating costs. These systems normally consume natural gas, oil, coal, coke and other hydrocarbon fuels that may be in short supply and may be expensive to bring to the operating site.

Systems of these types on the scale to process significant amounts of bulk material cost upwards of two million dollars with energy costs of eight to fifteen dollars per ton. These are significant expenses in reducing the moisture of the bulk material. Also, it is often necessary to process these bulk materials at or near the mining operation before the bulk material is transported any significant distance. The cost of transporting the fuel to operate these systems can be significant.

Thus, there is a need for a bulk material heating system that can efficiently reduce the moisture content of bulk materials in a cost effective manner and that can be readily constructed on site.

### SUMMARY OF THE INVENTION

The present invention provides a system for treating bulk materials to remove the moisture contained in the bulk materials. The system provides a heat exchanger system mounted in the floor of a bulk material bin. The heat exchanger transfers heat to the bulk materials to dry the bulk materials. The bin can be located at a bulk material loading station, which may be located in remote mining sites or in industrial plants. The system can dry any number of bulk materials ranging from metallic ores such as iron, gold, lead and others; commercial minerals; sands and shale containing petroleum products and any other type of moist bulk material.

In a preferred embodiment of the present invention, the system includes a heat exchanger system formed in or as the floor of a bulk material storage bin. The heat exchanger system includes a concrete substrate for mounting the storage bin. The heat exchanger system has a bottom plate on which a series of spaced beams are mounted. A top plate is mounted on the upper surface of the spaced beams. The spaced beams form conduits in communication with one another and serve as structural supports. Heated thermal fluid then flows through the conduits to transfer heat through the top plate to the bulk material stored in the bin. An insulating layer may be mounted beneath the bottom plate to limit heat loss and direct the heat flux upward to the bulk material. Dense rubber or other insulating materials can also be applied to the walls of the bins.

The system in a preferred embodiment also includes a heating unit or stove to heat the thermal fluid for use in the heat exchanger. The heating unit can be of any size, type or commercially available configuration capable of heat exchange via fluid or steam. For this preferred embodiment, the heating unit will provide about one million BTUs (British Thermal Units) of heat for the heat exchanger. The proper amount of heat in order to increase the bulk temperature from an initial X-value to a desired Y-value depends on the type of bulk material treated, the moisture content and how much moisture reduction is desired. In a preferred embodiment, the heating unit burns wood, biomass, coal or other readily available fuel sources. This greatly reduces the operating costs of the system. The heat exchanger can use water, steam, oil or other suitable thermal fluids for the heat exchange.

A condensation trap is used to trap the moisture from the heated bulk material in a preferred embodiment. The condensation trap is formed from an angled roof extending over the bin. The roof includes a sub roof extending spaced from the top roof to form an airflow channel. The heated air flows upward through the angled air flow channel. As the heated air flows upwardly through the channel, it cools and the moisture condenses on the sub roof. The condensation then flows downwardly into a gutter where it is collected. The flow of humid-air will be aided by directional blower-fans and draw curtains across the open or loading side of the bin and all open space below the tin roof.

The system of the preferred embodiment can be built for one tenth the cost of the existing bulk material drying systems. The energy cost for operating the preferred embodiment is also about three to ten percent of the operating costs of comparable existing drying systems.

With proper configuration of bin size, number of bins, thermal conductivity of material, hourly productivity balanced against hourly finished-transfer this system can provide continuous process batch drying.

These and other features will be evident from the ensuing detailed description of preferred embodiments and from the drawings.

### BRIEF DESCRIPTON OF THE DRAWINGS

FIG. 1 is a diagram of the bulk material drying system of a preferred embodiment of the present invention.

FIG. 2 is a schematic illustration of the heat exchange system of the system of FIG. 1.

FIG. 3 is a cross-sectional view of the heat exchange system of FIG. 1.

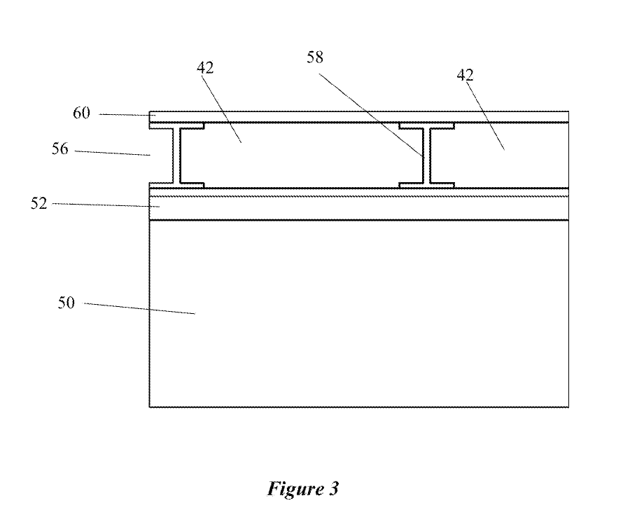

FIG. 4 is a schematic illustration of the condensation trap of the system of FIG. 1.

### DETAILED DESCRIPTONS OF PREFERRED EMBODIMENTS

The present invention provides a system for on or near site drying of materials, such as minerals, ores and other materials that may have a substantial moisture content. A preferred embodiment of this system is described herein for explanatory purposes. It is to be expressly understood that this exemplary embodiment is provided for descriptive purposes only and is not meant to unduly limit the scope of the present inventive concept. Other embodiments and uses of the present invention are included in the claimed inventions. It is to be expressly understood that other devices are contemplated for use with the present invention as well.

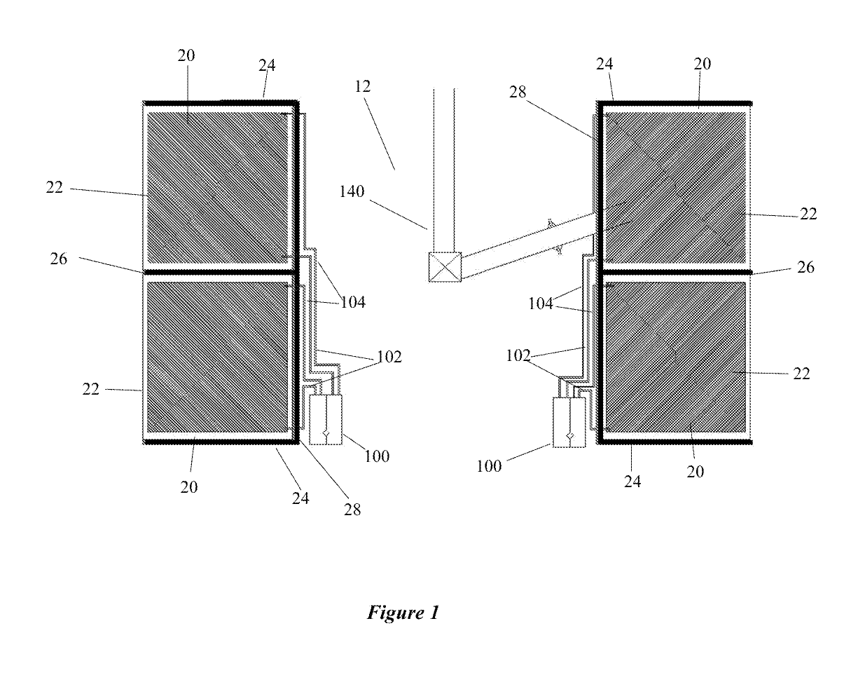

The system 10 of a preferred embodiment of the present invention utilizes at least one loading station 12 as shown in FIG. 1. Each of the loading stations includes one or more bays 20 for drying the material. In this preferred embodiment, iron ore is used as an example. It is to be expressly understood that other materials may be treated under the present invention including but not limited to other ores, minerals and almost any other material. The present invention is particularly useful for drying dense materials such as iron ore, gold, lead and other commercial minerals.

The bays 20 of the preferred embodiment are formed with a heated floor. The heated floor not only provides heat for drying the ore or other material but also must support the weight of the loaded bay and still remain stable under the dynamic environment of receiving and discharging of the material. In this preferred embodiment, a unique heat exchanging system 40 not only provides the heat for drying the material but also supports the weight of the material and is stable during the dynamics of the loading, heating and discharging operations.

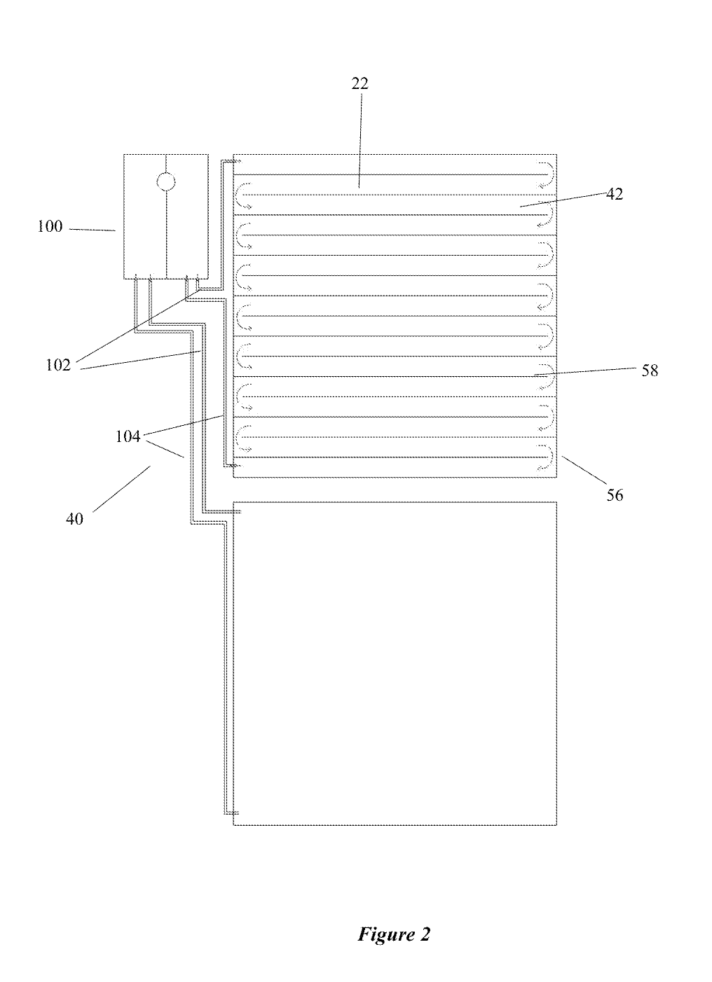

The bays include floor 22 and walls 24, 26, 28 as shown in FIG. 1. The heat exchanging system 40 shown in FIG. 2 is incorporated into the floor 22. In another preferred embodiment, the heat exchanging system 40 is also incorporated into the walls of the bays. As shown in FIG. 2, the heat exchanging system 40 includes a steel water jacket with a series of conduits 42 that extend under the floor 22. These conduits 42 are interconnected to transmit water, steam, oil or other thermal fluids beneath the floors 22 of the bins. The water or other fluids are transported from and returned to a heating system 100 discussed in greater detail below, via outlets 102 to the conduits 42 and returned back to the heating system 100 via returns 104.

The unique floor heat exchanging system 40 is mounted on top of a concrete substrate 50. In this preferred embodiment for processing dense materials weighing eight hundred (800) tons or more, the substrate 50 has a thickness of six inches of steel and fiber reinforced concrete. Preferably it is mounted on a compacted sub-grade to support the weight and dynamics of the bulk material in the bins 20. An insulative layer 52 is mounted on top of the substrate 50 to prevent heat loss to the ground. In this preferred embodiment, the insulative layer 52 is one inch thickness of dense black rubber. Other insulative materials may be used as well.

A bottom support plate 54 is mounted on top of the insulative layer 52. The bottom support plate 54 in this preferred embodiment is one half inch thick A572-50 grade steel plate. The plate must be sufficiently strong to support the weight of the material loaded in the bin 20. It is to be understood that other high strength materials may be used as well.

I-beam supports 56 are welded onto the bottom support plate 54 along the perimeter. Additional I-beam supports 58 are welded to the support plate 54 parallel to and spaced apart from the side perimeter I-beam supports 56. In this preferred embodiment, the I-beam supports 58 are spaced on sixteen inch centers from one another. Different spacing can be designed based on bulk material weight and requirement to maintain the deflection of the top plate in the elastic range with small deflections and no fracture. The I-beam supports 56 and 58, in this preferred embodiment are three inch seven point five pound I-beams. The space between the parallel I-beam supports 56, 58 form the conduits 42 for the fluid from the heating system 100. The ends of the I-beam supports 58 are spaced in a staggered manner in an alternating manner from the end I-beam supports 56 so the fluid can travel down one conduit 42 and enter into the next conduit.

Top support plate 60 is welded to the top surfaces of the I-beam supports 56, 58. The top support plate 60 is sufficiently strong to support the weight of the loaded material and able to conduct heat as well. In this preferred embodiment, the top support plate 60 is three-quarter inch thick A572-60 grade steel plate. Other high strength materials with adequate heat transfer characteristics may be used as well. The width and length of the top support plate 60, the bottom support plate 54, the insulative layer 52 and the concrete substrate are selected to hold the desired amount of material to be heated. In this preferred embodiment, the width and length of each component is twenty-four feet by twenty-four feet. The side walls of the bin are selected in this descriptive embodiment to be thirteen feet tall. This will hold approximately eight hundred wet tons of iron ore.

It is to be expressly understood that other sizes and thickness of components may be selected depending on the type, size and weight of the material to be heated. Also other material choices may be selected as well depending on the type, size and weight of the material to be heated.

The heating system 100 for the preferred embodiment of the present invention produces approximately one million (1,000,000) BTUs (British Thermal Units). In this preferred embodiment, the heating system uses a stove 110, preferably a wood burning stove or alternatively, coal, biomass and natural gas, propane or other conventional energy sources as well. The ability of the stove to burn wood, coal, biomass or other available energy sources enables it to be more environmentally sound in using existing energy materials, particularly if there is a local abundance of wood, coal, biomass, ethanol or other energy materials. It is to be expressly understood that the heat exchange device can be any heat exchange device of any size or configuration.

The stove 110 heats the heat exchanger fluid. The fluid can be water, steam, oil, or other thermal fluids. The heated fluid is transferred through the conduits 42 where the heat from the fluid is conducted through the top plate 60 and to the material stored in the bins 20. The fluid exits the heat exchanging system 40 and returns back to the stove 110 to be heated again. The system is a closed loop system with additional fluid being added as needed.

The heat transfer conduction of the top plate is equal to the thermal conductivity of the top plate 60 times the area of the plate times the difference between the hot temperature and the colder (material) temperature. Conduction also occurs between the different layers of the bulk material (conduction of the bulk material) where the thermal conductivity is of the bulk material, the area is the cross sectional area of the pile subjected to heat, the temperature difference is between the bottom and top surface. The rate of free convection of the fluid is equal to the convection heat transfer coefficient times the exposed area of the bulk material with the surrounding times the difference between the material temperature and the ambient temperature. In the descriptive embodiment above, the heat flux is approximately 800 W/m². The system as described in this embodiment heats the material to about one hundred eighty to two hundred degrees Fahrenheit. It is to be expressly understood that the system is able to heat the material to seven hundred degrees Fahrenheit and greater for other applications.

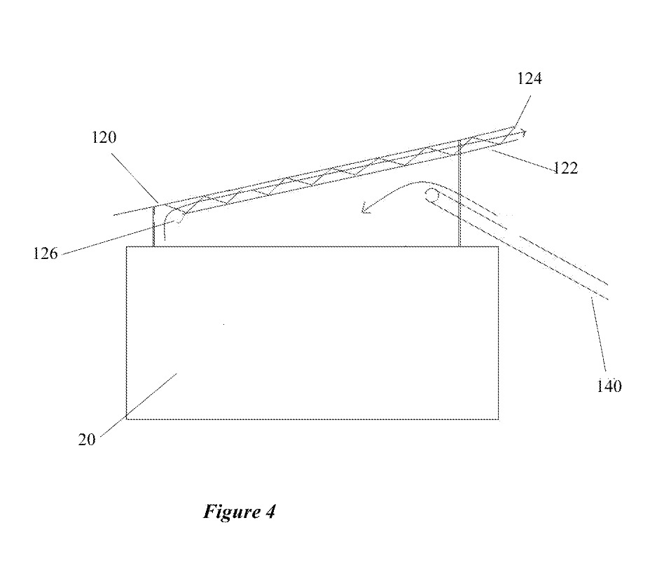

As the material is heated using the floor heat exchanging system, the moisture will evaporate from the bulk material. This moisture will condense on nearby surfaces as the heated air cools which may be a problem. To minimize this problem, a roof 120 is mounted above and spaced from the tops of the bins 20. The roof is mounted at an angle to the bins as shown in FIG. 4. A sub roof 122 is mounted beneath the roof 120 and spaced a distance from it to form a channel or air flow space 124. The moist airflow from the heated material is transmitted through the channel 124 since the heated air will naturally rise. A fan may also be used as well. As the heated air flows upward through the angled airflow channel 124, the air will cool causing the moisture from the air to condense on the sub roof. Gravity will cause the condensation to flow back down the channel into gutters 126 mounted on the sub roof 122. The gutters will transfer the condensation away from the material and structures.

In operation, the material to be heated is transferred to the bins 20 by conveyors 140, stacker feed units, loading equipment or other loading devices. In the descriptive embodiment, approximately eight hundred wet tons of iron ore is loaded into each bin 20. It is to be understood that multiple bins may be in use at the loading stations. Each bin will be constructed as described above with each bin having a separate stove 100. Also, a single stove may be used to heat fluid for multiple bins. The iron ore may have any moisture content above zero percent. The above described system can remove about fifteen percent moisture from the eight hundred tons wet of iron ore or other material in about thirty hours. The system of the descriptive embodiment is able to process about forty-five tons of dry iron ore per hour.

The system of the present invention is adaptable to other sizes of bins and for other applications. The above descriptive embodiment is intended for explanatory purposes only and is not meant to limit the scope of the claimed inventions. The system of the present invention is intended for use in heating bulk materials in order to reduce the moisture content. In the example described above, iron ore is heated to reduce the moisture content so the iron ore can be further treated for steel making. Other ores such as lead, gold and other metals, commercial minerals, oil sands, oil shale, soda ash, or any other bulk material may be heated through the floor heat exchanger as well. Also, heat exchangers may be used in the side walls of the bins as well.

These and other embodiments of the present invention are considered to be within the scope of the invention as claimed.

What is claimed is:

1. A system for heating bulk materials to reduce moisture content, said system comprising:
a bin for receiving bulk materials;
a floor in the lower surface of said bin; and
a heat exchanger in said floor for transferring heat through said floor and to the bulk materials in said bin.

2. The system of claim 1 wherein said heat exchanger includes:
a heating system for heating fluid; and
conduits beneath said floor for conducting fluid from said heating system so that heat is transferred from the heated fluid through said floor and to the bulk materials.

3. The system of claim 1 wherein said heat exchanger includes:
a heating system for heating fluid; and
conduits formed by spaced I-beams mounted beneath said floor for conducting fluid from said heating system so that heat is transferred from the heated fluid through said floor and to the bulk materials.

4. The system of claim 1 wherein said heat exchanger includes:
an insulating layer beneath said conduits.

5. The system of claim 1 wherein said heat exchanger includes:
a support substrate;
an insulative layer on said support substrate;
a bottom plate on said insulative layer; and
conduits on said bottom plate for conducting heated fluid.

6. The system of claim 1 wherein said heat exchanger includes:
a support substrate;
an insulative layer on said support substrate;
a bottom plate on said insulative layer;
beams mounted on said bottom plate and spaced from one another; and
a top plate mounted on said beams to form conduits on said bottom plate for conducting heated fluid.

7. The system of claim 1 wherein said heat exchanger includes:
a stove for providing heat for said heat exchanger.

8. The system of claim 1 wherein said heat exchanger includes:
any type of heat exchanger, including existing commercially available units for heat exchange or heat transfer.

9. The system of claim 1 wherein said heat exchanger includes:
a wood burning stove.

10. The system of claim 1 wherein said heat exchanger includes:
a biomass fueled stove.

11. The system of claim 1 wherein said heat exchanger includes:
a coal fueled stove.

12. The system of claim 1 wherein said heat exchanger includes:
a stove fueled by conventional energy sources.

13. The system of claim 1 wherein said heat exchanger includes:
providing heat up to seven hundred degrees Fahrenheit.

14. The system of claim 1 wherein said system further includes:
a condensation trap for capturing the condensation from the heated bulk material.

15. A system for heating bulk materials to reduce moisture content, said system comprising:
a bin for receiving bulk materials;
a floor in the lower surface of said bin;
a heating system for heating fluid;
conduits beneath said floor for conducting fluid from said heating system for transferring heat through said floor and to the bulk materials in said bin.

16. The system of claim 15 wherein said conduits are formed by spaced I-beams mounted beneath said floor for conducting fluid from said heating system so that heat is transferred from the heated fluid through said floor and to the bulk materials.

17. The system of claim 15 wherein said system includes:
an insulating layer beneath said conduits.

18. The system of claim 15 wherein said system includes:
a support substrate;
an insulative layer on said support substrate;
a bottom plate on said insulative layer;
beams mounted on said bottom plate and spaced from one another; and
a top plate mounted on said beams to form said conduits on said bottom plate for conducting heated fluid.

19. The system of claim 15 wherein said heating system includes:
a stove for providing heat for said heat exchanger.

20. The system of claim 15 wherein said heating system includes:
any type of heat exchanger, including existing commercially available units for heat exchange or heat transfer.

21. The system of claim 15 wherein said heating system includes:
a wood burning stove.

22. The system of claim 15 wherein said heating system includes:
a biomass fueled stove.

23. The system of claim 15 wherein said heating system includes:
a coal fueled stove.

24. The system of claim 15 wherein said heating system includes:
a stove fueled by conventional energy sources.

25. The system of claim 15 wherein said heating system includes:
a temperature range up to seven hundred degrees Fahrenheit.

26. The system of claim 15 wherein said system further includes:
a condensation trap for capturing moisture from the heated bulk material.

27. A system for heating bulk materials to reduce moisture content, said system comprising:
a bin for receiving bulk materials;
a stove for heating fluid;
a bottom plate in the lower surface of said bin;
an insulating layer beneath said bottom plate;
a plurality of spaced beams on said bottom plate; and
a top plate on said spaced beams forming conduits beneath said floor for conducting fluid from said stove for transferring heat through said floor and to the bulk materials in said bin.

28. The system of claim 27 wherein said stove provides approximately 1,000,000 BTUs.

29. The system of claim 27 wherein said stove includes:
any type of heat exchanger, including existing commercially available units for heat exchange or heat transfer.

30. The system of claim 27 wherein said stove includes:
a wood burning stove.

31. The system of claim 27 wherein said stove includes:
a biomass fueled stove.

32. The system of claim 27 wherein said stove includes:
a coal fueled stove.

33. The system of claim 27 wherein said stove includes:
a stove fueled by conventional energy sources.

34. The system of claim 27 wherein said stove provides a temperature range up to seven hundred degrees Fahrenheit.

35. The system of claim 27 wherein said system further includes:
a condensation trap for capturing moisture from the heated bulk material.
